(19) United States
(12) Patent Application Publication
(10) Pub. No.: US 2008/0026847 A1
(43) Pub. Date: Jan. 31, 2008

(54) Massive Multi Player Online Video Game that Progresses in Eras

(75) Inventors: Raymond J. Mueller, Palm Beach Gardens, FL (US); Andrew S. Van Luchene, Santa Fe, NM (US)

Correspondence Address: GONZALES PATENT SERVICES, 4605 CONGRESS AVE. NW, ALBUQUERQUE, NM, 87114, US

(73) Assignee: LEVIATHAN ENTERTAINMENT, LLC, Santa Fe, NM (US)

(21) Appl. No.: 11/735,138

(22) Filed: Apr. 13, 2007

Related U.S. Application Data
(63) Continuation-in-part of application No. 11/621,886, filed on Jan. 10, 2007.
Application No. 11/621,886 is a continuation-in-part of application No. 11/368,143, filed on Mar. 3, 2006.
(60) Provisional application No. 60/727,121, filed on Oct. 14, 2005.

(51) Int. Cl. G06F 17/00

(52) U.S. Cl. 463/42

(57) ABSTRACT

The present disclosure provides various novel concepts to a video game environment. The disclosed invention enables a game environment that progresses in discrete time frames such as eras or ages. Under certain controlled situations, play may return to previous eras via temporary time travel to alter or change the outcome of a previous era in an effort to ultimately improve the outcome of the current game environment.

### PRIORITY CLAIM

The present disclosure is a continuation-in-part of U.S. patent application Ser. No. 11/621,886 “Video Game with Reverse Outcome Attributes”, filed Jan. 10, 2007 and Ser. No. 11/368,143, “Video Game Methods and Systems” filed Mar. 3, 2006, which claims the benefit of U.S. Provisional Patent Application No. 60/727,121, “Methods, Processes and Systems to Enhance a Player Experience of a Video Game,” filed Oct. 14, 2005, each of which is hereby incorporated by reference.

### BACKGROUND

Video games which are accessible to multiple players via a server or peer to peer network are well known. For example, hundreds of thousands of players access games known as massive multi-player online games (MMOGs) and massive multi-player online role playing games (MMORPGs). Players of these games customarily access a game repeatedly (for durations typically ranging from a few minutes to several days) over a given period of time, which may be days, weeks, months or even years. The games are often constructed such that players pay a periodic subscription price (e.g., $15 per month) rather than, or in addition to, paying a one time purchase price for the game. Often, though not necessarily, these games have no ultimate “winner” or “winning goal,” but instead attempt to create an enjoyable playing environment and a strong player community.

Many conventional on-line video games utilize complex branching programs that dictate the conduct of game characters and the outcome of game situations in response to the current status of specific operating parameters. Traditional role playing games allow a user to control the development of a game character in response to specific queries, options, decisions, and interaction with other characters. Many video game programs are episodic, i.e., the game continues so long as the game character “survives” and progresses through various stages of the game. This surviving to progress system can become troubling to the lesser skilled player who often is required to repeat a particular level or episode countless times before “winning” or “conquering” a foe or various hazards within a level or episode before allowing advancement to another level or stage of the game. Unfortunately, with the traditional games, moving forward without acquiring every possible point, weapon, or attribute would be a poor option as it would likely leave the player weak or helpless in future levels or episodes—typically there are no means of curing the omission or oversight without starting the entire game over from the beginning.

It would be advantageous to provide improved methods for increasing the enjoyment and/or longevity of video games regardless of the player's skills including, but not necessarily limited to MMOGs and MMORPGs. This improved method should avoid game repetition or stagnation while adding unpredictable variety in adventures and outcomes.

### BRIEF DESCRIPTION OF THE DRAWINGS

FIG. 1 is a block diagram depicting a network according to an embodiment of the present disclosure.

FIG. 2 is a block diagram depicting a gaming system according to an embodiment of the present invention.

FIG. 3 is a flow diagram of a method of creating a new game environment according to an embodiment of the present invention.

FIG. 4 is a flow diagram of a method of altering the game environment when a new era occurs according to an embodiment of the present invention.

FIG. 5 is a flow diagram of a method of facilitating time travel according to an embodiment of the present invention.

FIG. 6 is a flow diagram of a method of sacrificing a player character according to an embodiment of the present invention.

FIG. 7 is a flow diagram of a method of creating a savior according to an embodiment of the present invention.

FIG. 8 is a flow diagram of three alternate methods of resetting the game parameters to the first era.

### DETAILED DESCRIPTION

Individuals involved in playing and participating in virtual environment games typically purchase the game or purchase user time of the game. When the individual has solved, won or reached the end of the game, they find no need to play it again or re-subscribe for additional user time as the path to the end result will likely be the same as previously experienced.

Various embodiments of the present invention address these issues by providing a game environment that progresses in discrete time frames, i.e., “ages” or “eras.” For example, at the inception of the game, the game environment may begin with a certain structure that can be altered in many ways as the game progresses forward through time. The alterations to the game environment are triggered by special occurrences as a result of player skill, lapse of time, system intervention, or other situations that can be controlled by player contribution, opposing player contribution, or the game system. The breadth of these alterations is so great that it is highly unlikely that the same path or progression could ever be repeated.

Massive multi player online games (MMOGs) or massive multi-player role-playing games (MMORPGs) are computer games which are capable of supporting hundreds, thousands, or millions of players simultaneously. Typically, this type of game is played in a giant persistent virtual world where the game may continue playing regardless of whether or not real players are logged in. Players commonly access these games through a network such as the Internet, and may or may not be required to purchase additional software or hardware in order to play the game. Such networks allow for people all over the world to participate and interact with each other in a virtual environment. The present disclosure provides systems and methods which contribute to the evolution and longevity of such a game.

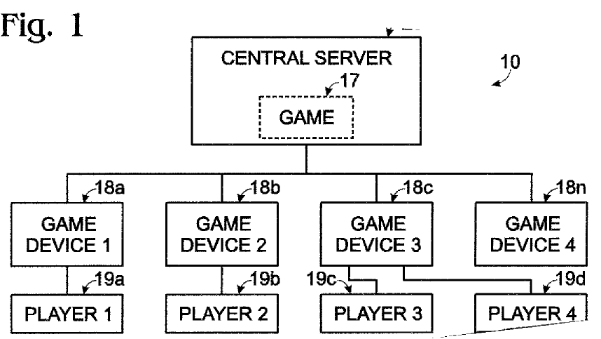

The herein described aspects and drawings illustrate components contained within, or connected with other components that permit play in the virtual environment. It is to be understood that such depicted designs are merely exemplary and that many other designs may be implemented to achieve the same functionality. Any arrangement of components to achieve the same functionality is effectively associated such that the desired functionality is achieved. FIG. 1 provides an exemplary network which may be used to support a virtual environment.

Referring to FIG. 1, a network 10 according to one embodiment includes a central server 20 in communication with a plurality of video game consoles or playing units 18. A video game console may include any device comprising a CPU, memory, optional permanent storage and/or other components residing at a player location that can allow for the interaction with or playing of video games. Examples include, home PCs, Microsoft Xbox, and Sony Playstation and/or any devices attached thereto, e.g., hand controllers, joysticks, etc.

Those of ordinary skill in the art will appreciate that any number of video game playing units may be in communication with the central server. A video game central server may include a CPU, memory and permanent or temporary storage that is connected to multiple Video Game Consuls that allows for Massive Multi Player Online Video Games to be played.

Typically, the number of video game playing units changes at various times as players join games and as players stop playing games. Similarly, more than one server may operate to coordinate the activities of the video game playing units, as is well known in the art.

Central server 20 may comprise any computing device (e.g., one or more computers) capable of communicating with other computing devices. The server 20 typically comprises a processor which is in communication with a storage device, such as an appropriate combination of RAM, ROM, hard disk, and other well known storage media. Central server 20 may comprise one or more personal computers, web servers, dedicated game servers, video game consoles, any combination of the foregoing, or the like.

Each video game device 18 may comprise any device capable of communicating with central server 20, providing video game information to a player, and transmitting the player's desired actions to the central server. Each video game device typically comprises a processor which is in communication with a storage device, such as an appropriate combination of RAM, ROM, hard disk, and other well known storage media. Suitable video game devices include, but are not limited to, personal computers, video game consoles, mobile phones, and personal data assistants (PDAs).

Some or all of video game 17 can be stored on central server 20. Alternatively, some or all of video game 17 may be stored on the individual video game devices 18. For the purposes of the present invention, a “video game” need not necessarily imply that players compete against each other or any entity. Accordingly, the term “video game” is intended to encompass virtual metaverses such as “Second Life” wherein players are able to interact with each other and the virtual environment through characters that are represented in the metaverse as avatars. Similarly, players may “play” the game simply by viewing, interacting with, or otherwise experiencing the virtual environment, and/or other avatars in the metaverse.

Typically, video game devices are able to communicate with one another, either directly, via central server 30, or via some other system or device. Such communication facilitates the ability for the players to interact with one another via the metaverse or game environment. Accordingly, a player 19a accessing video game 17 via game device 18a may be able to play with a player 19b accessing video game 17 via game device 18b. As shown, it may be possible for multiple players (e.g. 19c, 19d) to access central server 20 via the same game device (e.g. 18c).

For the purposes of the present disclosure, a “player” may be any person or entity that accesses a game. Generally, the player controls his, her, (or in the case of a computer player, its) character by manipulating or otherwise controlling a game device or somehow sending signals to the video game that the player's character is to perform (or not perform) a certain action or engage (or not) engage in a certain activity. Furthermore, a single player may control more than one character, simultaneously or at different times. Regardless of whether video game 17 is stored on central server 20 or video game devices 18, server 20 is typically configured to facilitate play of the game between multiple game players.

In some embodiments, a game may be administered by a game environment manager, which may be a player, group of players or any other entity capable of administering the game. A game environment manager may have the authority to create, change, or interpret rules related to game play, expel or ban players for inappropriate behavior, and perform other administrative-based tasks associated with the general management of the game.

Those having skill in the art will recognize that there is little distinction between hardware and software implementations. The use of hardware or software is generally a choice of convenience or design based on the relative importance of speed, accuracy, flexibility and predictability. There are therefore various vehicles by which processes and/or systems described herein can be effected (e.g., hardware, software, and/or firmware) and that the preferred vehicle will vary with the context in which the technologies are deployed.

At least a portion of the devices and/or processes described herein can be integrated into a data processing system with a reasonable amount of experimentation. Those having skill in the art will recognize that a typical data processing system generally includes one or more of a system unit housing, a video display device, memory, processors, operating systems, drivers, graphical user interfaces, and application programs, interaction devices such as a touch pad or screen, and/or control systems including feedback loops and control motors. A typical data processing system may be implemented utilizing any suitable commercially available components to create the gaming environment described herein.

According to various embodiments, there are a multitude of rules and structures possible to apply to each era or age within a game of this type. For example, the initial or a subsequent era for such a game may begin with a structure that may include:

1. a virtual geography

2. a virtual map of the geography

3. a group of game parameters that can be completed by player characters

4. a maximum population of player characters

5. a list of available resources or game attributes

6. a maximum group of resources or game attributes

7. a group of available player races

8. a group of available player classes

9. a group of available player attributes

10. a maximum size of a player character family tree

11. the types of skills a player character can acquire and/or develop

12. a group of available technologies

As one skilled in the art will appreciate, as a typical video game progresses through time, elevated challenges and degrees of difficulty are what tend to hold the interest of the player or players. The changing of character qualities as well as the attributes of the surrounding environment can help to make each level or era interesting and challenging to the participants. Accordingly, in various embodiments, a game as disclosed herein may be altered in various ways. Examples of ways in which the game may be altered include, but are not limited to:
1. the virtual geography becomes larger or smaller
2. the map of the virtual geography becomes larger, smaller or more or less defined
3. the group or number of game resources and/or attributes is changed, expanded, or reduced
4. the list or number of game resources and/or attributes is expanded, reduced, or altered
5. the maximum group or number of resources or game attributes is expanded, reduced or altered
6. the list of available player races is expanded, reduced or altered
7. a list of available player classes is expanded, reduced or altered
8. a list of available player attributes is expanded, reduced or altered
9. a maximum size of a player character family tree is expanded, reduced or altered
10. the types of skills a player character can acquire and/or develop is expanded, reduced or altered

Although one skilled in the art can imagine countless ways, events, or combinations of events that could lead to ending an era or level within a game of this type, a few examples might include:
1. a certain amount of virtual or actual time elapses
2. one or more player characters complete a game parameter
3. the game environment reaches a maximum population setting
4. an available attribute or resource is discovered or depleted
5. a certain section of the game geography is discovered, explored, or developed
6. a certain number of relationships has been established or dissolved between player characters
7. a certain number of play cycles are completed
8. a war between races, clans, or groups is won or lost
9. a certain number of players have entered or left the game

According to one embodiment, player characters can build, find, and use time travel devices that allow them to move from the present state of the server to another state, for example, the past. In some embodiments, player characters may be allowed to observe another era, such as the past without altering it. Accordingly, in this embodiment, the time travel device may serve as a history book or permanent record of the different eras that exist in a game environment.

As an alternative, by paying a fee, by acquiring a skill, or through use of an acquired item, such as a potion, talisman, or the like, players can travel back in time to replay a segment of the game, for example, to improve the outcome or to gain additional experience. In one embodiment, such replay episodes may be restricted to solitary game play, such as completing a task, solving a puzzle, etc. Accordingly, in some embodiments replays that require multiple players may be precluded. Alternatively, groups of two or more players may replay a particular episode together. A group replay may or may not require the consent of all affected parties.

In some embodiments, players may improve their condition in the present through engaging in time travel episodes. For example, a player may travel back to an earlier game environment where he can kill or perhaps maim an enemy who may be giving him grief in the present environment, thereby eliminating or lessening the power of this enemy in the present. In another example, a player character may travel back to an earlier era in an effort to acquire a special tool, weapon, or skill that he failed to get during a previous time in that era. This special tool, weapon, or skill may be one that he has found necessary to survive or prosper in the present era.

In some embodiments, characters may have attributes that can be developed, earned, and/or altered during a game. For the purposes of the present disclosure, an attribute may include any quality, trait, feature, or characteristic that can be associated with a particular Character. In some embodiments, each character may have an associated character account, in which a wide variety of character-related data may be stored. Accordingly, character attributes may be stored in a character account. Examples of character attributes include, but are not be limited to:

1. A character score
2. A genetic profile or makeup
3. A ranking
4. A relationship with another character
5. A score for subsequent matching of later game parameters
6. A skill or skill level
7. A virtual object
8. The ability to join groups of other players at a later time
9. The physical appearance of a character

According to one embodiment, certain items, and/or attributes may only be available in certain epochs or eras of the game. Accordingly, in some embodiments, if a certain item or attribute is not acquired by a player or group of players before an era of the game has elapsed, that player or group of players may be precluded from ever obtaining that item or attribute. For example, the “spider” mutation, which allows characters to walk on walls, may be available to any character who completes a particular task, say solves a spider riddle, in a particular era, e.g. “the Spider Age”. Once the Spider Age ends, characters who have obtained the spider mutation may or may not retain their wall walking abilities, however, the spider mutation may no longer be available to any other character.

However, according to some embodiments, time travel may provide an exception to this general rule. For example, a player character or group of players may be permitted or enabled to go back to the Spider Age, solve the spider riddle, and obtain the spider mutation. An attribute or item obtained via time travel may or may not come with the same or different limitations, rules, regulations, or restrictions, as an attribute or item that was obtained during a normal course of events.

According to one embodiment, restrictions may be imposed regarding how and when a particular player characters can be inserted into (i.e. begin) a game. For example, a game may have multiple races of characters, such as trolls, gremlins, humans, and each race may have an era in which a particular race is in power. Accordingly, the era in which a particular character is inserted may be dependant upon both the character's race and the race that is in power. For instance, trolls can only be inserted into a game when trolls are in power (or only when gremlins are in power, or only when humans are in power.) Accordingly, a particular player who wants to play a character having a particular race may have to wait until the game reaches the appropriate era. Of course it will be appreciated that a near limitless number of combinations of era requirements and character characteristic requirements are available.

Alternatively or additionally, different servers of the same game can be set or, optionally reset, to be on different eras of the game at the same time. Accordingly, the player in the paragraph above, may simply need to find an instance of the game which has reached the appropriate era. Alternatively, in an embodiment in which there are no restrictions regarding the era in which a character may start play, if there are multiple instances of the same game being played, a new player can elect to insert his character into any era of the game at any time.

According to one embodiment, a game may include an apocalypse. An apocalypse may take the form of a battle involving all or part of the existing player characters and may define the end of an era or the end of the game. According to one embodiment of the present invention, triggers for an apocalypse can include, but are not limited to:
1. a certain number of a certain race, class, guild, or family exists in the game environment
2. a certain age is reached in the game environment
3. one or more player characters acquires a certain game attribute
4. the Game Server starts an apocalypse. Within a peer-to-peer network this may be a random event or it may also be initiated when the system determines that a game is stagnant or uninteresting.

According to another embodiment, an apocalypse may allow one or more player characters of a player race, class, guild, or family to become a savior. A savior may be a special or superior character within a race, class, guild, or family who has superior leadership skills such as skills to lead an army or group of characters. This savior, or superior character may attempt, for example, to lead his army, which may include other player characters of his race, class, guild, or family to a total victory of the game. In this embodiment, total victory may be defined as the domination of the game environment. According to some embodiments, when total victory is obtained, the game environment is reset and the saviors may become the founding members of the reset or new game environment.

According to one embodiment, a player character may become a savior in a variety of ways. According to a first method, a player character may become a savior by acquiring a certain game attribute. For example, a game may include a special chalice which may be obtained, for example, by successfully completing a particularly arduous set of tests. A character who obtains the chalice may automatically become a savior, may chose to become a savior, or may select another player or character to become a savior.

Alternatively, a player character may become a savior by being reincarnated a certain number of times in the game. A particular game may provide methods by which a player may be reincarnated. For example, a character may be reincarnated by the casting of a particular spell by another character. Alternatively, characters that are killed in a certain way, or who die with a particular item in their possession may automatically be reincarnated. Accordingly, the game rules may provide that a character who has been reincarnated a certain number of times may automatically become, or be eligible to become a savior.

As a further alternative, a particular character may become a savior by being a certain x number in his family tree, guild, class, or race. Rules for identifying the birth order or characteristics that create a savior may be determined by the game designers, by a group of players, by the game administrator, or by any other suitable entity. Different rules may be available for different groups of people. For example, elves may state that the seventh daughter of a seventh son will always be a savior, while fairies may state that a single son born to a woman who has twelve sisters may qualify to be a savior. Accordingly, in some embodiments players may be able to manipulate their family trees in order to create a savior.

Alternatively or additionally, a character may become a savior after being sacrificed by his family, guild, class, or race. Various rules may exist regarding the sacrifice of a character for this purpose. For example, according to some rules, each family, guild, class, or race can sacrifice a player character so that player character can become eligible to become a savior and/or a certain class, race, or family member must exist to perform the sacrifice ritual.

Examples of sacrifice rituals include, but are not limited to:
1. casting a spell on a player character
2. killing a player character with a certain weapon
3. applying a character attribute (such as, but not limited to a spell) to a player character

More specific examples of sacrifice rituals include, but are not limited to:
1. an ore priest tears the heart out of the chest of the head of his family and plants it in a clay statue—the statue becomes the savior
2. an undead wizard casts a spell on the head of his family, who is devoured by maggots, the maggots grow into flies that recombine into one or more saviors
3. a dwarf engineer plants a cyborg brain into the head of his family—the brain controls the body of the player character and he becomes the savior
4. a group of human droids burn the head of their family at the stake—the ashes are placed into an urn and the savior rises from the ashes
5. the youngest or eldest family member or a virgin female family member is drawn and quartered on sacred grounds and then the body parts are cooked on a holy alter and subsequently devoured by the surviving family members—one or more of the family members becomes a savior

Alternatively, a savior may be created by the server or network. The timing of such savior creation may be random, based on an event, based on the passage of time in the game, or based on any other factor. For example, a particular game may be configured such that a new savior will be created every 24 hours of continuous game time. Alternatively, a savior may be created only after a particular event, such as large scale battle between two or more groups in the game.

As a further alternative, a savior may be endowed by a God with sufficient attributes or karma. For example, a game may include a God character who has the ability to endow one or more characters with one or more attributes. One of the attributes a God character could endow is saviorhood. A God may be required to have developed sufficient karma to endow characters with various attributes, including saviorhood. A description of how karma might be developed and used as a game device is described, for example, in U.S. patent application Ser. Nos. 11/421,026, 11/368,142, and 11/735,082, each of which is hereby incorporated by reference.

As a still further alternative, the ability to be a savior may be a purchasable attribute. Accordingly, a player can pay an additional fee for his character to have the ability to become a savior. In some embodiments, the fee may be paid in in-game currency. Alternatively, the game may be configured such that the fee must or may be paid in real currency.

According to one embodiment, saviors can create special player characters as family members to wage the war of the apocalypse. A family member may be, for example, a player character that has a parent/child relationship with one or more player characters in the same family tree. Examples for ways in which parent/child relationships may be formed in a virtual environment are described in U.S. patent application Ser. Nos. 11/621,880 and 11/694,669, each of which is hereby incorporated by reference.

In some embodiments, the goal of the apocalypse era is to kill the savior and army of other races, classes, guilds, or families first. The last savior standing may be declared the winner of the game for his class, guild, race, or family.

According to some embodiments, when the age of the apocalypse occurs, all player characters are notified. Notification may take place via an in-game voice or text-based messaging system, or via extra-game technologies, such as, for example, via text or voice mail message, to a cellular phone, land phone line, computer, handheld computer, PDA, dedicated or general mobile device or the like. An exemplary alerts system is described, for example, in U.S. patent application Ser. No. 11/676,858.

Additionally, progress and strengths of families, classes, races, or guilds (including whether or not that group of player characters includes a savior) may be displayed to all player characters in the game, for example, via a suitable notification system.

The apocalypse era may invoke various archetypical imagery and may or may not follow, incorporate, or alter images, story lines, and themes of known stories and traditions, including, but not limited to, the bible. For example, a particular embodiment in one embodiment, living saviors may be treated or referred to as Christ and his minions may be depicted as angels. Furthermore, undead saviors may be treated as Satan and his minions may be depicted as demons.

According to another embodiment,.saviors may be allowed to have children. The children or saviors may or may not have special attributes. For example, children of the savior may be born with wings and have the ability to fly.

In one embodiment, certain classes can have a randomly placed super player character created during each game era. Player characters that are super player characters may have special attributes and skills. For example, super player characters may be super scientists, artists, engineers, warriors, etc. In one embodiment, super player characters are mutations that can discover a new innovation than can be traded with other families, races, or classes. Families that are more powerful have greater odds of creating super player characters.

According to another embodiment, families or guilds may discover technologies that may be traded with other families and guilds in a way similar to the aforementioned super player characters. Theses technologies may be discovered when certain player characters reach certain levels of skill or acquire certain game attributes.

According to one embodiment, the entire group of characters that have a relationship (i.e., family or army) may have to reach certain cumulative experience or game level in order to add new characters to the group. Alternatively, a certain number of characters in the group may have to have a certain amount of experience or have obtained a certain level in the game before they, or other members of the group can have relationships with new or existing player characters.

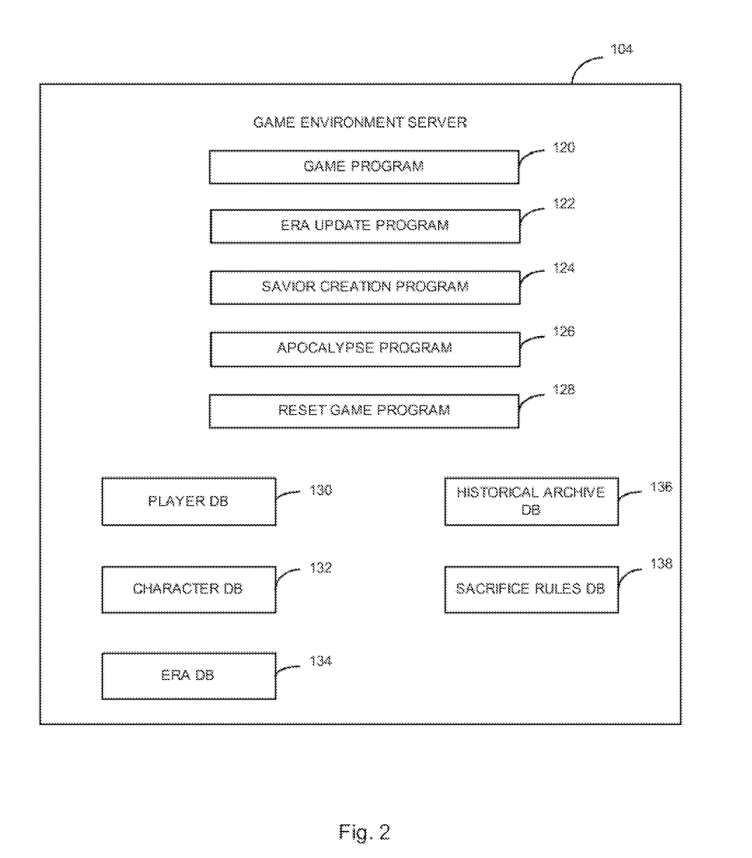

FIG. 2 provides an exemplary Game Environment Server 104 that may be used to provide the embodiments described above. As shown, Game Environment Server 104 may include Game Program 120, Era Update Program 122, Savior Creation Program 124, Apocalypse Program 126, and Reset Game Program 128. Game Environment Server 104 may additionally include databases such as Player Database 130, Character Database 132, Era Database 134, Historical Archives Database 136, and Sacrifice Rules Database 138.

Information regarding the players of the game may be stored, for example, in Player Database 130. In one embodiment, Player Database 130 may store information regarding player information and data such as a player guide, player billing information, player account settings, and a guide or listing of the player's characters.

According to one embodiment, as the game progresses, each character may acquire certain skills. In some instances the character may be required to fight an enemy, drink a potion, or perform some other task to gain strength enough to be qualified to be a savior. This character information may be stored, for example, in Character Database 132. Character Database 132 may also store information regarding each of the player's characters, a list of savior qualifications, and a list of savior attributes.

There may be many attributes and specific information relating to each era. This era specific information may be stored in Era Database 134 and may include data such as era identification, an era descriptor, era conditions 1-n, era time start, era time end, era populations 1-n, era classes 1-n, era races 1-n, era technologies 1-n, era natural resources 1-n, era skills 1-n, era rules 1-n, era limits 1-n, era territories 1-n, available game parameters 1-n, available game attributes 1-n, and family conditions 1-n.

According to one embodiment, this game has the ability to move forward and backward through time. Therefore, there likely will be significant data that must be stored from each previous encounter and era experience. This historical information may be stored, for example, in Historical Archive Database 136. This data base may include information such as saved game result identification, game area, game time, player characters involved, and a saved game result file.

As previously discussed, there may be a plurality of methods and rules involved in sacrificing players in order to create valuable saviors. These rules and methods may be stored, for example, in Sacrifice Rules Database 138. Sacrifice Rules Database 138 may include information such as sacrifice rule identification, sacrifice rules 1-n, and probability of sacrifice success.

The above listed databases and content of each database within Game Environment Server 104 are not intended to be a complete listing, but examples of some of the files and information that would be found in the various databases.

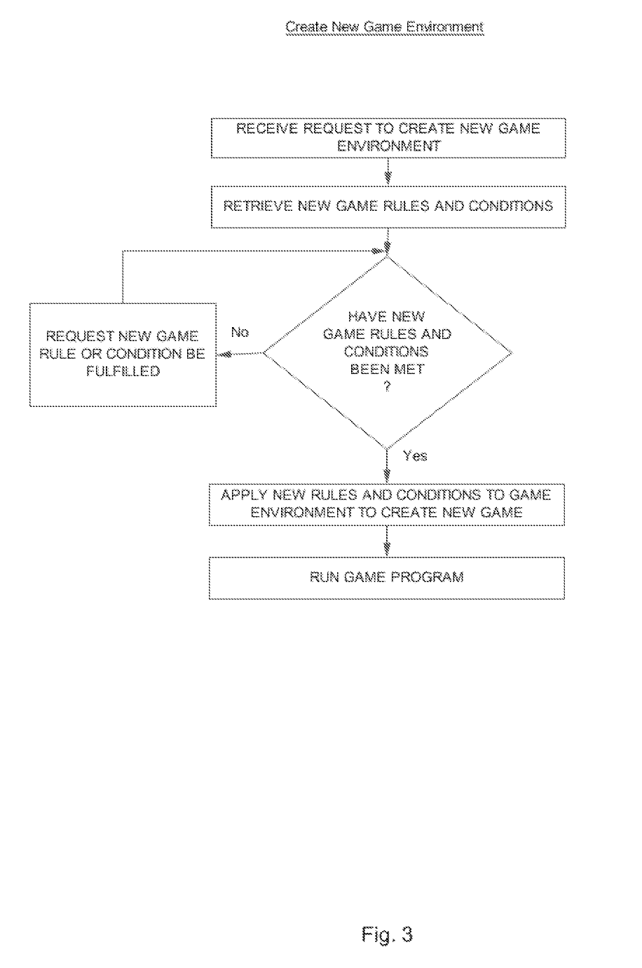

In one embodiment, a new game environment may be created, for example, by using some or all of the steps in the method outlined in FIG. 3. A request may be received to create a new game environment. New game rules and conditions may be retrieved. The game server or other controlling entity may query the appropriate database, to verify the new game rules and conditions have been met. If not, in one embodiment, a request may be made that the unfulfilled new game rule or condition be fulfilled. If the new game rules and conditions have been met, Game Program 120 may be run where the new game rules and conditions are applied to the game environment to create a new game.

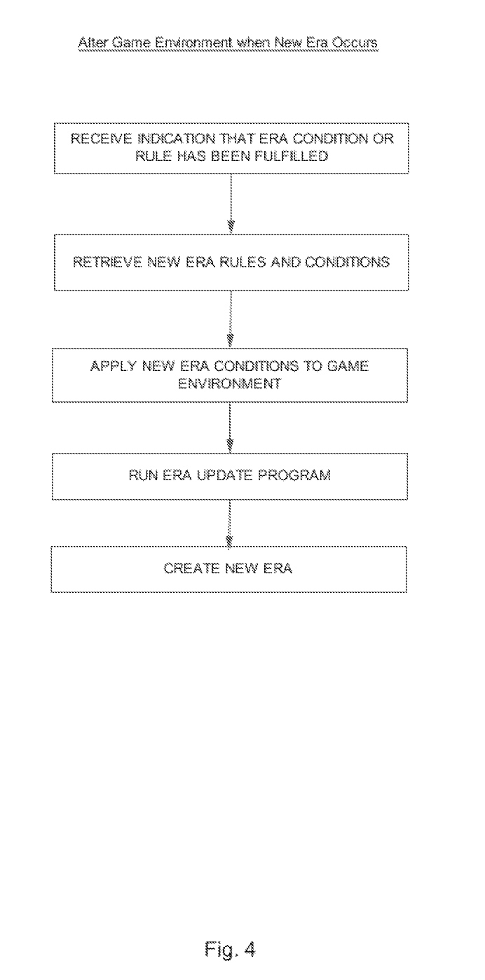

According to one embodiment, when a new era occurs, the game environment is altered in multiple ways according to the rules and conditions associated with the era. The method steps of FIG. 4 are one an example of this process. When an indication has been received by Game Environment Server 104 that an era condition or rule has been fulfilled, then the game will progress to a new era. Era Update Program 122 is run, and the new era rules and conditions are retrieved and applied to the game environment, and a new era is created.

There may be times that certain attributes, weapons or tools are not acquired by a player or group of players before an era of a game environment has elapsed. The player or group of players may not realize the importance of the missing attribute, weapon or tool until they have progressed to an era that requires this attribute, weapon or tool for strength or survival.

According to one embodiment, one way for a player or group of players to obtain a missing attribute, weapon or tool is to permit or enable the player or group of players to travel back in time and successfully complete a particular task or acquire a needed attribute. In a situation where certain items, character mutations or attributes are only available in certain epochs or eras of the game, time travel may allow the player character to correct a previous error by replaying a segment of the game. Upon return to the present game environment, a successful replay may allow the player or group of players to return to the latest segment or era of the game with improved status, weapons, attributes, or tools.

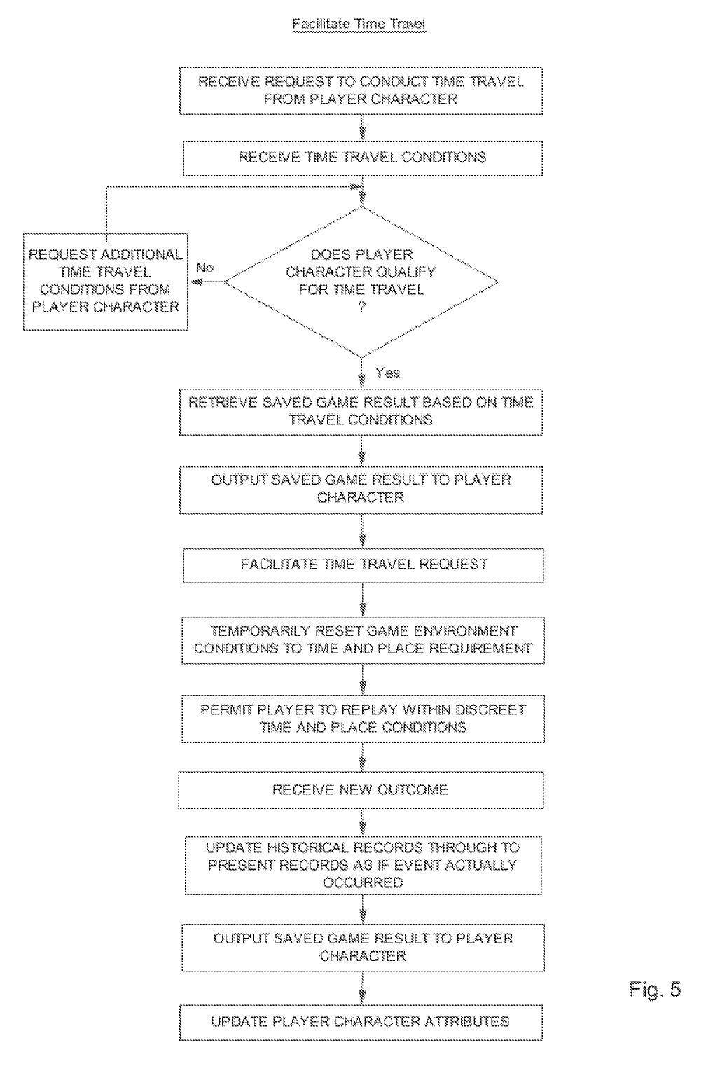

According to another embodiment of the present invention, players can build, find, and use time travel devices that will allow them to move from the present state of the server to the past. With this time travel device, players can travel back in time to replay a segment of the game to improve the outcome or to gain additional experience or skills needed in the present state of the game. In one embodiment, time travel can be facilitated by using some or all of the steps in the method outlined in FIG. 5. In this example method, a request is received to conduct time travel from a player character. The player character also provides the time travel conditions. The player character database is queried to verify that the player character is qualified for time travel. If not, additional time travel conditions are requested from the player character before time travel is allowed. If the player character is qualified, the saved game results may be retrieved based on the time travel conditions requested. The saved game results may be displayed to the player character and the time travel may be facilitated. In this example, the game may be temporarily reset to an earlier game environment and conditions according to the time and place requirements specified in the player character's time travel conditions. The player character then replays a particular segment of that era thereby receiving a new outcome to this portion of the game. The historical records may be updated in Historical Archive Database 136 through to the present records as if the event actually occurred in the original era. The saved game result may be outputted to the player character and the player character attributes may be updated in Character Database 132.

In yet another embodiment, in an effort to improve a previous game environment outcome, a player character may, for example, simply exit the game and, if this player character is of superior status, such as a savior or super player character, the player character may re-enter the game at the era he chooses to replay. Upon the player's satisfaction with this past era, the player character may again exit the game and return to the present game environment now possessing a newly acquired skill or weapon, or enjoy the elimination of a troublesome enemy. Again, as in the previous embodiment, the historical records may be updated in Historical Archive Database 136 through to the present records as if the event actually occurred in the original era. The saved game result may be outputted to the player character and the player character attributes may be updated in Character Database 132.

According to various embodiments, there are numerous desirable attributes of saviors, such as strength, leadership, durability, etc. Therefore, the more saviors in a race, class, guild, or family, the more power the group will likely be. For example, saviors can lead their armies, which may consist of other player characters of his same race, class, guild, or family to total victory of the game. Saviors can also, for example, create special player characters as family members to wage a battle or the war of the apocalypse.

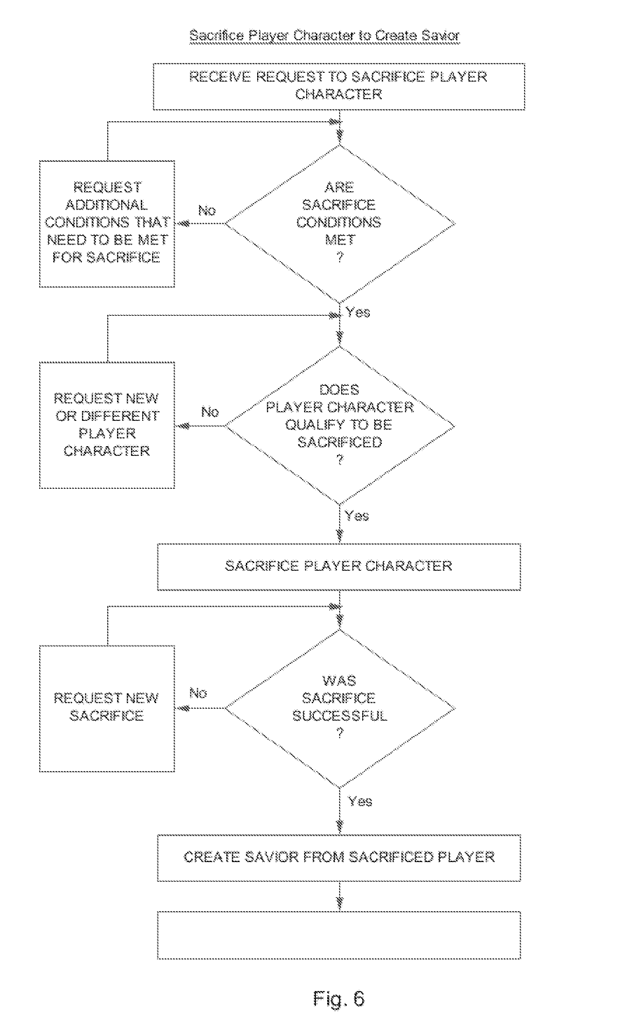

In one embodiment, one method of creating a savior is by a family, guild, class or race sacrificing a player member. FIG. 6 is a flow diagram of one embodiment of a process for sacrificing a player character to create a savior. In this embodiment, Game Environment Server 104 receives a request to sacrifice a player character. Sacrifice Rules Database 138 is queried to determine if the sacrifice conditions are met. If not, additional conditions that need to be met for the sacrifice may be requested. If the conditions are met, Character Database 132 is queried to determine if the player character qualifies to be sacrificed. If not, a new or different player character is requested for the sacrifice. If the player character does qualify for sacrifice, the player character is sacrificed according to the rules in Sacrifice Rules Database 136.

Following the sacrifice of the player character in FIG. 6, Game Environment Server 104 queries the success of the sacrifice. If the sacrifice was not a success, a new sacrifice may be requested. If the sacrifice was successful, then Savior Creation Program 124 runs thereby creating a new savior for the sacrificing race, class, guild or family.

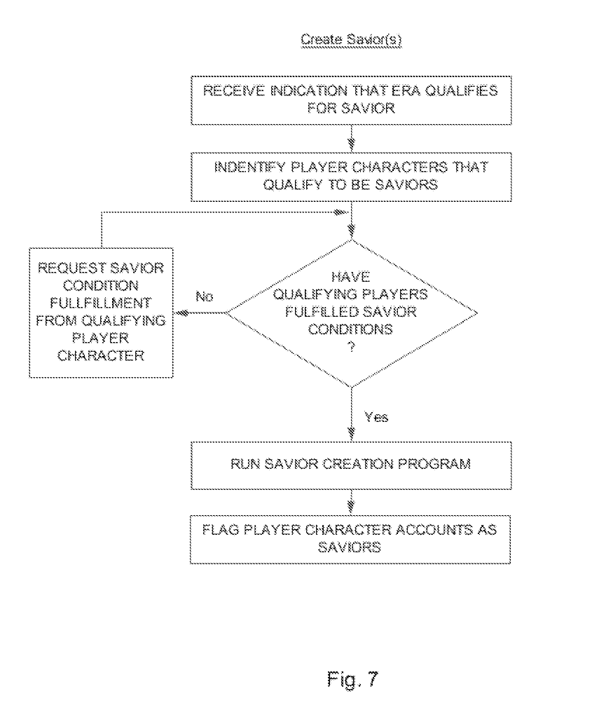

According to one embodiment, an example method of Game Environment Server 104 creating a savior is outlined in the steps of FIG. 7. Game Environment Server 104 receives indication that the current era qualifies for a savior. The player characters that qualify to be saviors are identified. Character Database 132 is queried to verify that the qualifying players have fulfilled the savior conditions. If the savior conditions have not been met, savior condition fulfillment is requested. If the qualifying players have fulfilled the savior conditions, Savior Creation Program 124 is run and the player character accounts are flagged as saviors. Character Database 132 is updated with the new savior information.

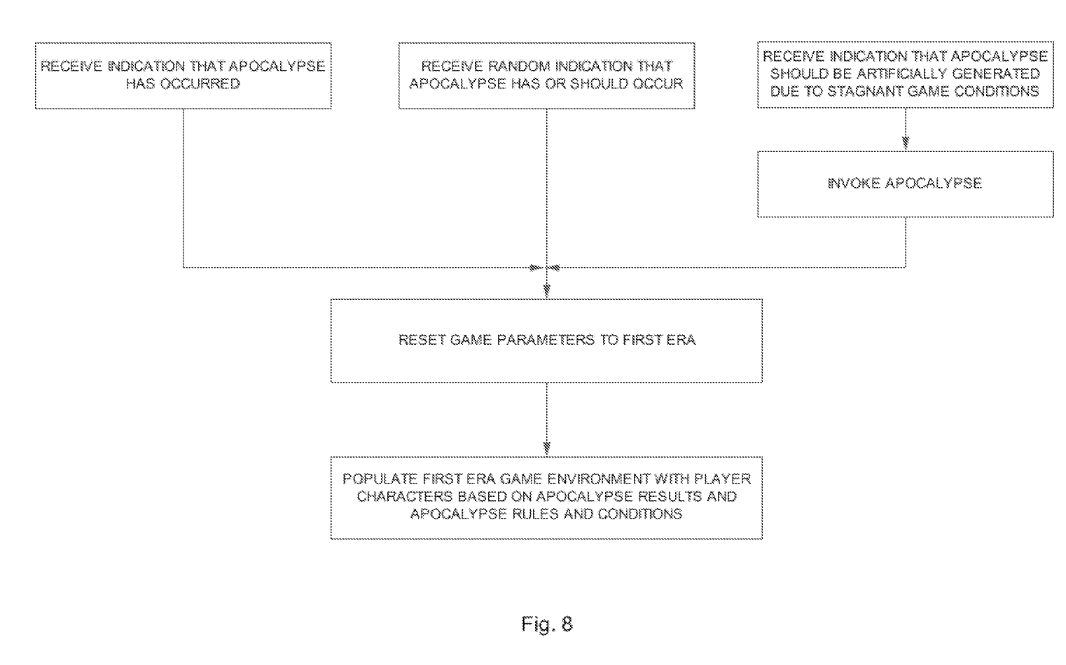

In one embodiment, total victory of the game is defined as the domination of the game environment. In this embodiment, when total victory is obtained, the game environment is reset. The saviors become the founding members of the reset or new game environment. Typically, the reset goes back to the first era. As outlined in FIG. 8, there are at least three situations that may lead to a reset of the game parameters to the first era. The first example situation is when Game Environment Server 104 receives indication that an apocalypse has occurred. A second example situation is when the game randomly indicates that an apocalypse should occur. In this situation, Game Environment Server 104 will invoke an apocalypse by running Apocalypse Program 126. A third example situation is when Game Environment Server 104 receives indication that an apocalypse should be artificially generated due to stagnant game conditions. Again, Game Environment Server 104 will run Apocalypse Program 126. Following any of the above three example situations, Reset Game Program 128 is run where the game parameters are reset to the first era. Upon reset, in one embodiment the first era game environment is populated with player characters based on the apocalypse results and apocalypse rules and conditions.

It will be appreciated that while, for the sake of discussion, various databases have been described separately, the data in these and any other suitable databases could be merged into a single large database and/or maintained separately in additional databases, or in other structures besides a database. Moreover, any such databases could be independent or linked, and the data in these databases could be stored centrally on a server or separately on game devices.

The present disclosure provides numerous systems and methods related to virtual environments in online computer games. It should be appreciated that numerous embodiments are described in detail and that various combinations and subcombinations of these embodiments are contemplated by the present disclosure.

Of course it will be appreciated that the systems methods described herein are provided for the purposes of example only and that none of the above systems methods should be interpreted as necessarily requiring any of the disclosed components or steps nor should they be interpreted as necessarily excluding any additional components or steps. Furthermore, it will be understood that while various embodiments are described, such embodiments should not be interpreted as being exclusive of the inclusion of other embodiments or parts of other embodiments.

The invention is described with reference to several embodiments. However, the invention is not limited to the embodiments disclosed, and those of ordinary skill in the art will recognize that the invention is readily applicable to many other diverse embodiments and applications as are reflected in the range of real world financial institutions, instruments and activities. Accordingly, the subject matter of the present disclosure includes all novel and nonobvious combinations and subcombinations of the various systems, methods configurations, embodiments, features, functions, and/or properties disclosed herein.

The term “variation” of an invention includes any embodiment of the invention, unless expressly specified otherwise.

A reference to “another embodiment” in describing an embodiment does not necessarily imply that the referenced embodiment is mutually exclusive with another embodiment (e.g., an embodiment described before the referenced embodiment), unless expressly specified otherwise.

The terms “include”, “includes”, “including”, “comprising” and variations thereof mean “including but not limited to”, unless expressly specified otherwise.

The term “consisting of” and variations thereof includes “including and limited to”, unless expressly specified otherwise. The terms “a”, “an” and “the” mean “one or more”, unless expressly specified otherwise.

The term “plurality” means “two or more”, unless expressly specified otherwise.

The term “herein” means “in this patent application, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel.

The phrase “based on” does not mean “based only on”, unless expressly specified otherwise. In other words, the phrase “based on” describes both “based only on” and “based at least on”.

The term “represent” and like terms are not exclusive, unless expressly specified otherwise. For example, the term “represents” does not mean “represents only”, unless expressly specified otherwise. In other words, the phrase “the data represents a credit card number” describes both “the data represents only a credit card number” and “the data represents a credit card number and the data also represents something else”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The terms “such as”, “e.g.” and like terms means “for example”, and thus does not limit the term or phrase it explains. For example, in the sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “determining” and grammatical variants thereof (e.g., to determine a price, determining a value, determine an object which meets a certain criterion) is used in an extremely broad sense. The term “determining” encompasses a wide variety of actions and therefore “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like. It does not imply certainty or absolute precision, and does not imply that mathematical processing, numerical methods or an algorithm process be used. Therefore “determining” can include estimating, predicting, guessing and the like.

It will be readily apparent to one of ordinary skill in the art that the various processes described herein may be implemented by, e.g., appropriately programmed general purpose computers and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions.

A “processor” may include one or more microprocessors, central processing units (CPUs), computing devices, microcontrollers, digital signal processors, or like devices or any combination thereof. Thus a description of a process is likewise a description of an apparatus for performing the process. The apparatus can include, e.g., a processor and those input devices and output devices that are appropriate to perform the method. Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

The term “computer-readable medium” includes any medium that participates in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth™, and TCP/IP, TDMA, CDMA, and 3G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Just as the description of various steps in a process does not indicate that all the described steps are required, embodiments of an apparatus include a computer/computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) are well known and could be used to store and manipulate the data types described herein. Likewise, object methods or behaviors of a database can be used to implement various processes, such as the described herein. In addition, the databases may, in a known manner, be stored locally or remotely from any device(s) which access data in the database.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, or a combination of any of the above). Each of the devices may themselves comprise computers or other computing devices, such as those based on the Intel® Pentium® or Centrino™ processor, that are adapted to communicate with the computer. Any number and type of devices may be in communication with the computer.

In an embodiment, a server computer or centralized authority may not be necessary or desirable. For example, the present invention may, in an embodiment, be practiced on one or more devices without a central authority. In such an embodiment, any functions described herein as performed by the server computer or data described as stored on the server computer may instead be performed by or stored on one or more such devices.

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

Each claim in a set of claims has a different scope. Therefore, for example, where a limitation is explicitly recited in a dependent claim, but not explicitly recited in any claim from which the dependent claim depends (directly or indirectly), that limitation is not to be read into any claim from which the dependent claim depends.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device or article is described herein, more than one device/article (whether or not they cooperate) may alternatively be used in place of the single device/article that is described. Accordingly, the functionality that is described as being possessed by a device may alternatively be possessed by more than one device/article (whether or not they cooperate).

Similarly, where more than one device or article is described herein (whether or not they cooperate), a single device/article may alternatively be used in place of the more than one device or article that is described. For example, a plurality of computer-based devices may be substituted with a single computer-based device. Accordingly, the various functionality that is described as being possessed by more than one device or article may alternatively be possessed by a single device/article.

The functionality and/or the features of a single device that is described may be alternatively embodied by one or more other devices which are described but are not explicitly described as having such functionality/features. Thus, other embodiments need not include the described device itself, but rather can include the one or more other devices which would, in those other embodiments, have such functionality/features.

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments of the invention nor a listing of features of the invention which must be present in all embodiments.

Neither the Title (set forth at the beginning of the first page of this patent application) nor the Abstract (set forth at the end of this patent application) is to be taken as limiting in any way as the scope of the disclosed invention(s). An Abstract has been included in this application merely because an Abstract of not more than 150 words is required under 37 C.F.R. §1.72(b).

The title of this patent application and headings of sections provided in this patent application are for convenience only, and are not to be taken as limiting the disclosure in any way.

Devices that are described as in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for long period of time (e.g. weeks at a time). In addition, devices that are in communication with each other may communicate directly or indirectly through one or more intermediaries.

A description of an embodiment with several components or features does not imply that all or even any of such components/features are required. On the contrary, a variety of optional components are described to illustrate the wide variety of possible embodiments of the present invention(s). Unless otherwise specified explicitly, no component/feature is essential or required.

Although process steps, algorithms or the like may be described in a sequential order, such processes may be configured to work in different orders. In other words, any sequence or order of steps that may be explicitly described does not necessarily indicate a requirement that the steps be performed in that order. On the contrary, the steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not imply that all or any of the steps are essential or required. Various other embodiments within the scope of the described invention(s) include other processes that omit some or all of the described steps. Unless otherwise specified explicitly, no step is essential or required.

Although a product may be described as including a plurality of components, aspects, qualities, characteristics and/or features, that does not indicate that all of the plurality are essential or required. Various other embodiments within the scope of the described invention(s) include other products that omit some or all of the described plurality.

Unless expressly specified otherwise, an enumerated list of items (which may or may not be numbered) does not imply that any or all of the items are mutually exclusive. Therefore it is possible, but not necessarily true, that something can be considered to be, or fit the definition of, two or more of the items in an enumerated list. Also, an item in the enumerated list can be a subset (a specific type of) of another item in the enumerated list. For example, the enumerated list “a computer, a laptop, a PDA” does not imply that any or all of the three items of that list are mutually exclusive—e.g., an item can be both a laptop and a computer, and a “laptop” can be a subset of (a specific type of) a “computer”.

Likewise, unless expressly specified otherwise, an enumerated list of items (which may or may not be numbered) does not imply that any or all of the items are collectively exhaustive or otherwise comprehensive of any category. For example, the enumerated list “a computer, a laptop, a PDA” does not imply that any or all of the three items of that list are comprehensive of any category.

Further, an enumerated listing of items does not imply that the items are ordered in any manner according to the order in which they are enumerated.

In a claim, a limitation of the claim which includes the phrase “means for” or the phrase “step for” means that 35 U.S.C. §112, paragraph 6, applies to that limitation.

In a claim, a limitation of the claim which does not include the phrase “means for” or the phrase “step for” means that 35 U.S.C. §112, paragraph 6 does not apply to that limitation, regardless of whether that limitation recites a function without recitation of structure, material or acts for performing that function. For example, in a claim, the mere use of the phrase “step of” or the phrase “steps of” in referring to one or more steps of the claim or of another claim does not mean that 35 U.S.C. §112, paragraph 6, applies to that step(s).

With respect to a means or a step for performing a specified function in accordance with 35 U.S.C. §112, paragraph 6, the corresponding structure, material or acts described in the specification, and equivalents thereof, may perform additional functions as well as the specified function.

Computers, processors, computing devices and like products are structures that can perform a wide variety of functions. Such products can be operable to perform a specified function by executing one or more programs, such as a program stored in a memory device of that product or in a memory device which that product accesses. Unless expressly specified otherwise, such a program need not be based on any particular algorithm, such as any particular algorithm that might be disclosed in this patent application. It is well known to one of ordinary skill in the art that a specified function may be implemented via different algorithms, and any of a number of different algorithms would be a mere design choice for carrying out the specified function.

Therefore, with respect to a means or a step for performing a specified function in accordance with 35 U.S.C. §112, paragraph 6, structure corresponding to a specified function includes any product programmed to perform the specified function. Such structure includes programmed products which perform the function, regardless of whether such product is programmed with (i) a disclosed algorithm for performing the function, (ii) an algorithm that is similar to a disclosed algorithm, or (iii) a different algorithm for performing the function.

The present disclosure provides, to one of ordinary skill in the art, an enabling description of several embodiments and/or inventions. Some of these embodiments and/or inventions may not be claimed in this patent application, but may nevertheless be claimed in one or more continuing applications that claim the benefit of priority of this patent application. Applicants intend to file additional applications to pursue patents for subject matter that has been disclosed and enabled but not claimed in this patent application.

We claim:

1. A method comprising:
providing a game environment in which player characters interact and complete at least one game parameter within a plurality of eras;
assigning a status to the player character based on completion of the game parameters in each of the eras;
receiving a request from a player character to travel from a current era to a different era; and
transporting the player character to the different era based on the request.

2. The method of claim 1 further comprising:
allowing the player character to complete at least one of the game parameters within the different era;
upgrading the status of the player character based on the game parameter completed in the different era.

3. The method of claim 2 further comprising returning the player character to the current era wherein the player character continues play with the status upgrade.

4. The method of claim 1 wherein the different era is a previously played era.

5. The method of claim 1 wherein transporting the player character to the different era further comprises the step of:
determining if the player character is qualified to return to the previous era.

6. The method of claim 1 further comprising the steps of:
receiving indication that a new era should begin;
retrieving a new set of era rules and conditions;
applying the new set of era rules and conditions; and
beginning a new era.

7. The method of claim 5 wherein receiving an indication that a new era should begin is initiated by an apocalypse.

8. The method of claim 7 wherein the apocalypse is initiated by an event.

9. The method of claim 8 wherein the event is a character player indication that an apocalyptic battle has occurred.

10. The method of claim 8 wherein the event is a random system indication that an apocalyptic battle should occur.

11. The method of claim 8 wherein the event is a stagnant game condition.

12. A method comprising:
providing a game environment in which at least one player character interacts with at least one non-player character, the player character completing at least one game parameter within a plurality of eras;
assigning a status to the player character based on completion of the game parameters in each of the eras;
receiving a request from a player character to travel from a current era to a different era;
transporting the player character to the different era.

13. The method of claim 12 further comprising:
allowing the player character to attempt to complete at least one of the game parameters within the different era.

14. The method of claim 13 wherein, if the player character successfully completes at least one of the game parameters, the method comprises:
upgrading the status of the player character based on the game parameter completed in the previous era.

15. The method of claim 13 further comprising returning the player character to the current era wherein the player character continues play with the status upgrade.

16. The method of claim 12 wherein transporting the player character to the different era further comprising the steps of:
assessing the status of the player character for transporting qualifications;
for a qualified player character, recalling a set of saved game conditions from the different era;
outputting the set of saved game conditions to the qualified player character; and
allowing the qualified player character to replay the different era.

17. The method of claim 16 further comprising:
receiving a new outcome for the different era;
updating the status of the qualified player character and the set of saved game conditions with a new result; and
returning to the current era with the new result.

18. A method comprising:
providing a game environment wherein players interact with each other via avatars; the game environment being configured to progress through a series of eras;
initiating an apocalypse to end a current era;
assessing a player character's qualifications for upgrading the player character to a savior, the savior having superior skills to the player characters;
creating the savior with the qualifying player characters.

19. The method of claim 18 further comprising determining that a savior has defeated all enemies in the game environment; and
beginning a new era in the game environment with the savior and any followers of the savor.

20. The method of claim 18 wherein the savior is created by sacrificing a player character.
